(19) United States
(12) Patent Application Publication
(10) Pub. No.: US 2025/0184792 A1
(43) Pub. Date: Jun. 5, 2025

(54) COMMUNICATION METHOD AND COMMUNICATION APPARATUS

(71) Applicant: BEIJING XIAOMI MOBILE SOFTWARE CO.,LTD., Beijing (CN)

(72) Inventor: Xiandong DONG, Beijing (CN)

(73) Assignee: BEIJING XIAOMI MOBILE SOFTWARE CO., LTD., Beijing (CN)

(21) Appl. No.: 18/845,234

(22) PCT Filed: Mar. 10, 2022
(86) PCT No.: PCT/CN2022/080244

§ 371 Date: Sep. 9, 2024

(51) Int. Cl. H04W 24/10

(52) U.S. Cl. CPC H04W 24/10

(57) ABSTRACT

A communication method, performed by an access point, includes: sending a null data packet announcement (NDPA) frame, where the NDPA frame carries a sensing measurement setup identifier; sending a null data packet (NDP) frame; and sending a trigger frame, where the trigger frame comprises first information, and the first information indicates feeding back a measurement result of a sensing measurement instance corresponding to at least one sensing measurement setup.

### CROSS-REFERENCE TO RELATED APPLICATIONS

The present application is a U.S. national phase application of International Application No. PCT/CN2022/080244, filed on Mar. 10, 2022, the entire disclosure of which is incorporated herein by reference.

### FIELD

The present disclosure relates to the field of wireless communications, and particularly to a communication method and a communication apparatus.

### BACKGROUND

Wireless local area network (WLAN) has the characteristics of flexibility, mobility and low cost. With the development of the communication technology and the growth of user needs, a deep application research for WLAN is continuously performed. For example, WLAN sensing is currently being studied, and it may be applied in scenarios, such as location discovery, proximity detection, and presence detection in a cluttered environment (e.g., a home environment and an enterprise environment).

### SUMMARY

According to embodiments of the present disclosure, there is provided a communication method, applied to an access point, including: sending a null data packet announcement (NDPA) frame, where the NDPA frame carries a sensing measurement setup identifier; sending a null data packet (NDP) frame; and sending a trigger frame, where the trigger frame includes first information, and the first information indicates feeding back a measurement result of a sensing measurement instance corresponding to at least one sensing measurement setup.

According to embodiments of the present disclosure, there is provided a communication method, applied to a station, including: receiving a null data packet announcement (NDPA) frame, where the NDPA frame carries a sensing measurement setup identifier; receiving a null data packet (NDP) frame; performing sensing measurement corresponding to the sensing measurement setup identifier according to the NDPA frame and the NDP frame; receiving a trigger frame, where the trigger frame includes first information, and the first information indicates feeding back a measurement result of a sensing measurement instance corresponding to at least one sensing measurement setup; sending the measurement result according to the trigger frame.

According to embodiments of the present disclosure, there is provided an electronic device including: a memory, a processor, and a computer program stored in the memory and executable by the processor. The processor is configured to execute the computer program to perform the method described above.

According to embodiments of the present disclosure, there is provided a non-transitory computer-readable storage medium having stored therein a computer program that, when executed by a processor, causes the method described above to be implemented.

### BRIEF DESCRIPTION OF THE DRAWINGS

The above and other features of embodiments of the present disclosure will become apparent by describing in detail embodiments of the present disclosure with reference to the accompanying drawings, in which:

FIG. 1A shows an example of a manner for WLAN sensing;

FIG. 1B shows an example of a manner for WLAN sensing;

FIG. 1C shows an example of a manner for WLAN sensing;

FIG. 2 is a flowchart of a communication method according to an embodiment;

FIG. 3 is a flowchart of a communication method according to an embodiment;

FIG. 4 is a flowchart of a communication method according to another embodiment; and

FIG. 5 is a block diagram illustrating a communication apparatus according to an embodiment.

### DETAILED DESCRIPTION

The following description with reference to the accompanying drawings is provided to assist in a comprehensive understanding of various embodiments of the present disclosure as defined by the appended claims and their equivalents. Various embodiments of the present disclosure include specific details, but these specific details are considered to be explanatory only. Additionally, descriptions of well-known techniques, functions, and constructions may be omitted for clarity and conciseness.

Terms used by the inventor in the embodiments of the present disclosure are only for providing a clear and consistent understanding of the present disclosure, and are not limited to the literal meanings. Accordingly, to those skilled in the art, the description of the various embodiments of the present disclosure is provided for the purpose of describing specific embodiments, and shall not be construed to limit the present disclosure.

It will be understood that, as used herein, “a,” “an,” and “the” in a singular form are intended to include plural forms, unless clearly indicated in the context otherwise. It should be further understood that the term “including” as used in the present disclosure refers to the presence of the described features, integers, steps, operations, elements and/or components but does not exclude the presence or addition of one or more other features, integers, steps, operations, elements, components and/or groups thereof.

It will be understood that terms such as “first” and “second” may be used herein for describing various elements, these elements should not be limited by these terms. These terms are only used for distinguishing one element from another. Accordingly, a first element discussed below may be termed a second element without departing from the teachings of the embodiments.

It will be understood that when an element is referred to as being “connected” or “coupled” to another element, it may be connected or coupled to the other element directly or via an intervening element. Additionally, “connected” or “coupled” as used herein may include wireless connections or couplings. As used herein, the term “and/or” or the expression “at least one of” refers to any one of associated listed items or any combination of one or more of the associated listed items.

Unless otherwise defined, all terms (including technical and scientific terms) used herein may be commonly understood by one ordinary skill in the art to which the present disclosure belongs.

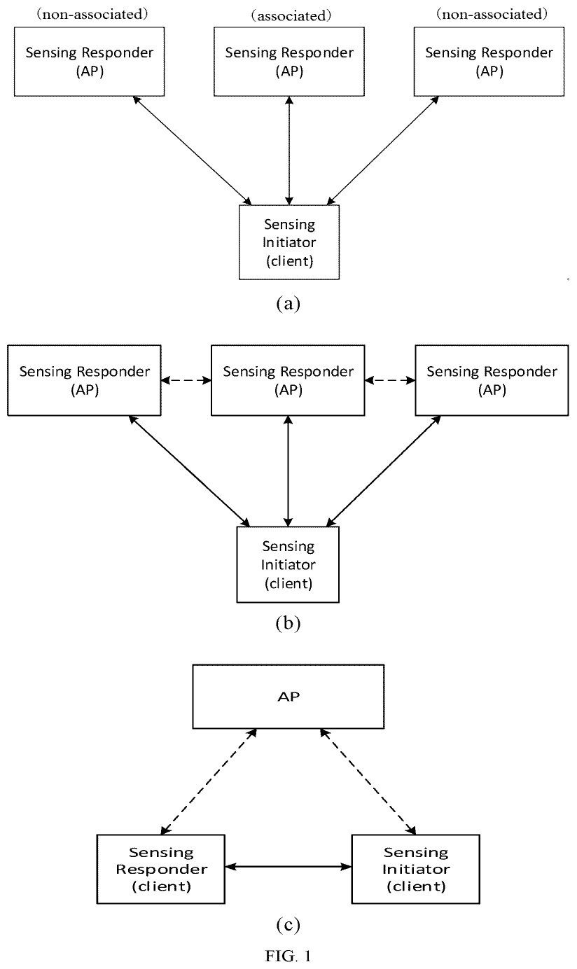

FIG. 1A, FIG. 1B and FIG. 1C show examples of a manner for WLAN sensing.

A process of the WLAN sensing may be as follows. An initiator initiates the WLAN sensing (for example, initiates a WLAN sensing session), and multiple responders respond to it. Specific possible manners may be as shown in FIG. 1A, FIG. 1B and FIG. 1C.

Referring to in FIG. 1A, when a WLAN sensing initiator (e.g., a client) initiates the WLAN sensing, multiple associated or non-associated WLAN sensing responders (e.g., three access points (APs)) may respond. “Associated” here may mean that an associated connection for communication has been established between the initiator and the responder, and “non-associated” may mean that no associated connection for communication has been established between the initiator and the responder.

For example, the client may include, but is not limited to, a cellular phone, a smartphone, a wearable device, a computer, a personal digital assistant (PDA), a personal communications system (PCS) device, a personal information manager (PIM), a personal navigation device (PND), a global positioning system, a multimedia device, an Internet of Things (IoT) device.

The AP may be a wireless switch used for a wireless network or an access device for the wireless network. The AP may include software applications and/or circuitry to enable other types of nodes in the wireless network to communicate with outside and inside of the wireless network through the AP. For example, the AP may be a terminal device or a network device equipped with a wireless fidelity (Wi-Fi) chip.

FIG. 1B is similar to FIG. 1A, but in FIG. 1B, communication may occur between individual responders (APs).

Referring to FIG. 1C, both the WLAN sensing initiator and the WLAN sensing responder may be clients, and they may communicate with each other by connecting to the same AP.

Although it is shown in FIG. 1A, FIG. 1B and FIG. 1C that the client serves as the initiator and the AP serves as the responder, the present disclosure is not limited thereto. For example, according to embodiments of the present disclosure, the AP may serve as the initiator, and the client may serve as the responder. In addition, although in the above embodiments, the term “client” is used to describe the responder, the present disclosure is not limited thereto. For example, according to embodiments of the present disclosure, a non-AP station (hereinafter referred to as “station (STA)”) may serve as the responder, and its embodiment may be similar to the above-mentioned client embodiment. For conciseness, repeated descriptions are omitted here. Furthermore, the number of initiators and responders is not limited to those shown in FIG. 1A, FIG. 1B and FIG. 1C.

As an illustrative embodiment, the process of WLAN sensing may include: WLAN sensing session setup, WLAN sensing measurement setup, WLAN sensing measurement, WLAN sensing report, or WLAN sensing termination. In the WLAN sensing session setup, operating parameters associated with the sensing session may be determined and exchanged between devices. In the WLAN sensing measurement setup, one or more WLAN sensing measurements may be established for each WLAN sensing session and identified by a sensing measurement setup identifier (measurement setup ID). In addition, for each WLAN sensing measurement setup identifier, one or more WLAN sensing measurement instances may be setup and may be identified with a sensing measurement instance identifier (measurement instance ID). In the WLAN sensing measurement, sensing measurement may be performed for one or more WLAN sensing measurement instances. In the WLAN sensing report, sensing measurement result(s) may be reported. In the WLAN sensing termination, the device stops the measurement and terminates the sensing session. It will be understood that the various stages included in the above-mentioned WLAN sensing process are only explanatory, and the present disclosure is not limited thereto. Some of the stages may be omitted or combined, or the WLAN sensing process may be split in different ways.

In an embodiment of the WLAN sensing report, the initiator may first send a trigger frame to allocate a resource unit (RU) to the responder (for example, STA), and instruct the responder to report the measurement result or feed the measurement result back. The responder may selectively send one or more measurement results (such as, but not limited to, channel state information (CSI)) to the initiator with the RU indicated in the trigger frame sent by the initiator.

However, in the existing research, the mechanism for using trigger frame to trigger the measurement result feedback is not yet complete and needs to be enhanced.

In view of this, a communication method and a communication apparatus according to embodiments of the present disclosure are provided.

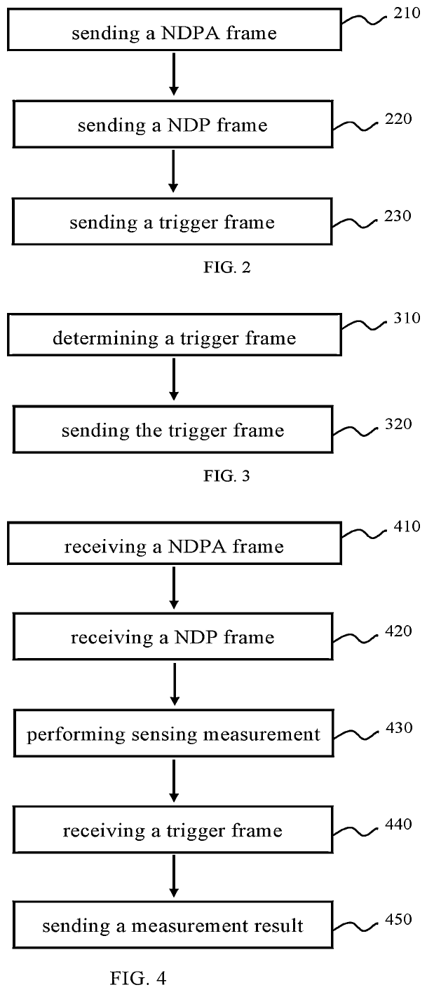

FIG. 2 is a flowchart of a communication method according to an embodiment. The communication method shown in FIG. 2 may be applied to an initiator of the WLAN sensing, for example, an access point (hereinafter may be referred to as “AP” for short).

Referring to FIG. 2, in block 210, a null data packet announcement (NDPA) frame is sent, where the NDPA frame carries a sensing measurement setup identifier (measurement setup ID). In other words, the communication method shown in FIG. 2 may correspond to the WLAN sensing measurement phase and the WLAN sensing report phase in the above-mentioned WLAN sensing process, and the sensing measurement setup identifier (measurement setup ID) may be determined or allocated by the AP during the WALN sensing setup phase before the communication method shown in FIG. 2 is performed. In block 210, the transmitted NDPA frame carries a sensing measurement setup identifier (measurement setup ID), thereby identifying for which sensing measurement setup identifier (measurement setup ID) the sensing measurement to be initiated.

In block 220, a null data packet (NDP) frame is sent. For example, the NDP frame may be called a WLAN sensing frame for WLAN sensing measurement. In a non-limiting example, the NDP frame may include operating parameter(s) required to perform the WLAN sensing measurement, such as the number of spatial streams, an operating bandwidth of the NDP frame, a long training field (LTF), and a packet extension (PE).

Although FIG. 2 shows that an NDPA frame and an NDP frame are sent in block 210 and block 220, respectively, embodiments of the present disclosure are not limited thereto. In the communication method shown in FIG. 2, blocks 210 and 220 may be performed multiple times, that is, multiple NDPA frames and NDP frames are sent sequentially or simultaneously to initiate multiple WLAN sensing measurements. In this case, the measurement setup identifier corresponding to (or carried by) each NDPA frame is different. Alternatively, NDPA frames containing the same measurement setup identifier correspond to different measurement instances, so that the WLAN sensing measurement is initiated for different measurement instances with the same measurement setup identifier. For example, in addition to carrying the measurement setup identifier, each NDPA frame may further carry a measurement instance identifier (measurement instance ID) corresponding to the measurement setup identifier, so that the WLAN sensing measurement corresponding to the measurement instance identifier is performed.

In block 230, a trigger frame is sent. The trigger frame is used to trigger at least one responder (STA) to send a measurement result. For example, the trigger frame may include first information, and the first information indicates feeding back a measurement result of a sensing measurement instance corresponding to at least one sensing measurement setup.

In a descriptive example, the first information may be included in a common info field of the trigger frame. In addition, the common info field may further include: a bandwidth (for example, an uplink bandwidth (UL BW)) used for feeding the measurement result back. For example, the bandwidth (for example, the UL BW) may be identified as 20, 40, 80, 160, or 320 MHz bandwidth.

According to an embodiment of the present disclosure, the first information may include: at least one sensing measurement setup identifier respectively corresponding to at least one sensing measurement. In other words, the trigger frame may trigger a feedback of a measurement result of the sensing measurement instance corresponding to the at least one sensing measurement setup identifier.

For example, the trigger frame sent in block 230 may be used to trigger a delayed feedback or a prompt feedback. For example, if the trigger frame triggers the prompt feedback, the first information may include one measurement setup identifier (measurement setup ID) or one or more measurement instance identifiers (measurement instance IDs) corresponding to the one measurement setup identifier (measurement setup ID), so that the responder may send the sensing measurement result corresponding to the measurement setup identifier (measurement setup ID) or the one or more measurement instance identifiers (measurement instance IDs) carried in the first information. For example, if the trigger frame triggers the delayed feedback, the first information may include multiple measurement setup identifiers (measurement setup IDs) or one or more measurement instance identifiers (measurement instance IDs) corresponding to each measurement setup ID.

In an embodiment of the present disclosure, the first information may include one sensing measurement setup identifier. For example, when the first information only contains the sensing measurement setup identifier and does not include its corresponding measurement instance identifier(s), the trigger frame carrying such first information may indicate that the responder needs to feed back the measurement results corresponding to all measurement instances contained in the sensing measurement setup identifier. For example, the first information may include one sensing measurement setup identifier and measurement instance identifiers corresponding to the one sensing measurement setup identifier, and the trigger frame may indicate that the responder needs to report measurement results of the corresponding measurement instances contained in the sensing measurement setup identifier.

In another embodiment of the present disclosure, the first information may include two or more sensing measurement setup identifiers. The sensing measurement setup identifier may be identified in different ways. In an example, when the first information only contains two or more sensing measurement setup identifiers and does not contain their respective measurement instance identifiers, the trigger frame may indicate that the responder needs to feed back the measurement results corresponding to all measurement instances contained in each sensing measurement setup identifier. In another example, the first information may include two or more sensing measurement setup identifiers and their respective measurement instance identifiers, and the trigger frame may indicate that the responder needs to report measurement results of the corresponding measurement instances contained in each sensing measurement setup identifier.

According to another embodiment of the present disclosure, the communication method may include first information: a start value of at least one sensing measurement setup identifier and an end value of the at least one sensing measurement setup identifier. For example, if the start value of the at least one sensing measurement setup identifier is that ID=1 and the end value of the at least one sensing measurement setup identifier is that ID=3, the trigger frame indicates that the STA needs to feed back measurement results corresponding to three sensing measurement setup identifiers. When only containing the start value of the at least one sensing measurement setup identifier and the end value of the at least one sensing measurement setup identifier and containing no respective measurement instance identifier(s), the trigger frame may indicate that the responder needs to feed back the measurement results corresponding to all measurement instances contained in each of the at least one sensing measurement setup identifier. However, the present disclosure is not limited thereto. For example, the first information may further include: at least one sensing measurement instance identifier corresponding to each of the at least one sensing measurement setup identifier.

According to another embodiment of the present disclosure, the communication method may include first information: a start value of at least one sensing measurement setup identifier and a number of the at least one sensing measurement setup identifier. For example, if the start value of the at least one sensing measurement setup identifier is that ID=1 and the number of the at least one sensing measurement setup identifiers is 4, the trigger frame indicates that the STA needs to feed back the measurement results corresponding to the four sensing measurements setup IDs starting from ID=1. When the first information only contains the start value of the at least one sensing measurement setup identifier and the number of the at least one sensing measurement setup identifier but does not contain the respective measurement instance identifiers, the trigger frame may indicate that the responder needs to feed back the measurement results corresponding to all measurement instances contained in each of the at least one sensing measurement setup identifier. However, the present disclosure is not limited thereto. For example, the first information may further include: at least one sensing measurement instance identifier corresponding to each of the at least one sensing measurement setup identifier.

According to another embodiment of the present disclosure, the communication method may include first information: individually indicating at least one sensing measurement instance identifier corresponding to each sensing measurement setup identifier, as shown in the following Table 1. In Table 1, measurement setup ID1, measurement setup ID2 and the like indicate the sensing measurement setup identifiers, and measurement instance ID11, measurement instance ID12 and the like indicate the sensing measurement instance identifiers corresponding to the sensing measurement setup ID1. Measurement instance ID21, measurement instance ID22 and the like indicate the sensing measurement instance identifiers corresponding to the sensing measurement setup ID2. The trigger frame containing each identifier shown in Table 1 may indicate that the responder feeds back measurement results of sensing measurement instances corresponding to measurement instance ID11, measurement instance ID12, measurement instance ID21, and measurement instance ID22.

TABLE 1

| | | | | | | | |
|---|---|---|---|---|---|---|---|
| measurement | measurement | measurement | . . . | measurement | measurement | measurement | . . . |
| setup ID1 | instance ID11 | instance ID12 | | setup ID2 | instance ID21 | instance ID22 | |

According to another embodiment of the present disclosure, the communication method may include first information: the sensing measurement instance identifier being identified as (or including): a start value of at least one sensing measurement instance identifier (i.e., a sensing measurement instance start identifier) and an end value of the at least one sensing measurement instance identifier (i.e., a sensing measurement instance end identifier), as shown in Table 2 below.

TABLE 2

| | | | | | | | |
|---|---|---|---|---|---|---|---|
| measurement | measurement | measurement | . . . | measurement | measurement | measurement | . . . |
| setup ID1 | instance start | instance end | | setup ID2 | instance start | instance end | |
| | ID1 | ID1 | | | ID2 | ID2 | |

In Table 2, measurement instance start ID1 and measurement instance end ID1 may respectively indicate a start value of the at least one sensing measurement instance identifier and an end value of the at least one sensing measurement instance identifier corresponding to the sensing measurement setup ID1, and measurement instance start ID2 and measurement instance end ID2 may respectively indicate a start value of the at least one sensing measurement instance identifier and an end value of the at least one sensing measurement instance identifier corresponding to the sensing measurement setup ID2.

According to another embodiment of the present disclosure, the communication method may include first information: the sensing measurement instance identifier being identified as (or including): a start value of at least one sensing measurement instance identifier and a number of the at least one sensing measurement instance identifiers, as shown in Table 3 below.

TABLE 3

| | | | | | | | |
|---|---|---|---|---|---|---|---|
| measurement | measurement | number of | . . . | measurement | measurement | number of | . . . |
| setup ID1 | instance start | instances 1 | | setup ID2 | instance start | instances 2 | |
| | ID1 | | | | ID2 | | |

In Table 3, measurement instance start ID1 and the number of instances 1, may respectively indicate the start value of the at least one sensing measurement instance identifier and the number of the at least one sensing measurement instance identifier corresponding to the sensing measurement setup ID1, and measurement instance start ID2 and the number of instances 2, may respectively indicate the start value of the at least one sensing measurement instance identifier and the number of the at least one sensing measurement instance identifier corresponding to the sensing measurement setup ID2.

It will be understood that although in Tables 2 and 3, the sensing measurement setup identifiers are identified as separate identifiers, the present disclosure is not limited thereto. For example, Tables 2 and 3 may be modified differently. For example, Table 4 shows a modified embodiment.

TABLE 4

| | | | | | | |
|---|---|---|---|---|---|---|
| measurement | number of | measurement | measurement | measurement | measurement | . . . |
| setup start | measurement | instance start | instance end | instance start | instance end | |
| ID | setups | ID1 | ID1 | ID2 | ID2 | |

In Table 4, measurement setup start ID and the number of measurement setups respectively indicate a start value of the at least one sensing measurement setup identifier and the number of the at least one sensing measurement setup identifier. Measurement instance start ID1 and measurement instance end ID1 may respectively indicate a start value and an end value of at least one sensing measurement instance identifier corresponding to an initial sensing measurement setup identifier, and measurement instance start ID2 and measurement instance end ID2 may respectively indicate a start value and an end value of at least one sensing measurement instance identifier corresponding to a next sensing measurement setup identifier after the initial sensing measurement setup identifier.

It will be understood that the forms shown in Tables 1 to 4 are only examples, and the present disclosure is not limited thereto. For example, contents, positions and/or sequences shown in Tables 2 to 4 may be changed differently according to an identification manner of the sensing measurement setup identifier (i.e., being identified in a manner of the start value of the at least one sensing measurement setup identifier and the end value of the at least one sensing measurement setup identifier or a manner of the start value of the at least one sensing measurement setup identifier and the number of the at least one sensing measurement setup identifier) and/or an identification manner of the at least one sensing measurement instance identifier (i.e., being identified in a manner of the start value of the at least one sensing measurement instance identifier and the end value of the at least one sensing measurement instance identifier or a manner of the start value of the at least one sensing measurement instance identifier and the number of the at least one sensing measurement instance identifier).

According to embodiments of the present disclosure, the trigger frame may have different formats. For example, since the trigger frame is used to trigger at least one STA to send prompt/delayed measurement result(s), the trigger frame may contain a start value of the at least one measurement setup identifier and an end value of the at least one measurement setup identifier. For example, the start value of the at least one measurement setup identifier is that ID=1 and the end value of the at least one measurement setup identifier is that ID=3, the STA needs to feed back measurement results corresponding to the three measurement setup identifiers. Alternatively, for example, the trigger frame may contain the start value of the at least one measurement setup identifier and a number of the at least one measurement setup identifier. For example, the starting value of the at least one measurement setup identifier is that ID=1, and the number of the at least one measurement setup identifier is 3, the STA needs to feed back measurement results corresponding to three measurement setup identifiers. Alternatively, for example, the trigger frame may contain at least one measurement instance identifier corresponding to each of the at least one measurement setup identifier (e.g., each measurement setup identifier may include one or more measurement instances), so as to indicate that it needs to feed back a result of the at least one measurement instance corresponding to each of the at least one the measurement setup identifier.

According to an embodiment of the present disclosure, if the trigger frame contains the measurement setup identifier, it may not include corresponding measurement instance identifier, and this may indicate that the responder needs to feed back measurement results corresponding to all measurement instances contained in the measurement setup identifier.

According to an embodiment of the present disclosure, if the trigger frame only contains one or more measurement setup identifiers, it may include multiple corresponding measurement instance identifiers, for example, a start value and an end value of the measurement instance identifiers, or the start value of the measurement instance identifiers and a number of the measurement instance identifiers.

According to an embodiment of the present disclosure, before transmitting the trigger frame, the AP will send the NDPA frame and the NDP frame for downlink sensing measurement (may send the frames for multiple times, and each NDPA frame corresponds to a different measurement setup identifier, or the NDPA frame containing the same measurement setup identifier corresponds to a different measurement instance).

According to an embodiment of the present disclosure, there may be different forms of trigger frames. For example, the AP sends a trigger frame to perform uplink sensing measurement, and the responder (STA) may send the NDP frame to the initiator, so that the AP may use the NDP frame to perform the WLAN sensing measurement. In this case, since the AP performs the WLAN sensing measurement, the trigger frame is not used to trigger reporting the measurement result. In order to distinguish this form of trigger frame, an identifier bit for differentiation may be set in the trigger frame in an embodiment according to the present disclosure. For example, the trigger frame may further include: a type identifier for indicating that the trigger frame is a frame indicating to feed back the measurement result.

Although the various information contained in the trigger frame is described above, the present disclosure is not limited thereto. For example, the trigger frame may further include an identifier of the station, so that the trigger frame is sent to the corresponding station that needs to feed back the measurement result. For example, the identifier of the station may be identified by AID or UID, where AID represents an identifier of the station that has established associated communication with the initiator AP, and UID represents an identifier of the station that has not established associated communication with the initiator AP. However, the present disclosure is not limited thereto. For example, the trigger frame may include a media access control (MAC) address of the station.

FIG. 3 is a flowchart of a communication method according to an embodiment. The communication method is applied to the initiator AP.

As shown in FIG. 3, in block 310, the trigger frame is determined.

The trigger frame may include various different contents, which will be described in detail with reference to different embodiments below. In embodiments of the present disclosure, the trigger frame may be determined in different manners. For example, the trigger frame may be generated or configured according to at least one of the following conditions: a WLAN sensing accuracy requirement, a channel state, a network condition, a load condition, a hardware capability of a transmitting/receiving device, a service type, and a relevant protocol provision, which are not limited in the present disclosure. In the embodiments of the present disclosure, the trigger frame may be obtained from an external device, which is not limited in the embodiments of the present disclosure.

In block 320, the trigger frame is sent. For example, the trigger frame may be sent to at least one responder STA to trigger the corresponding STA to feed back the measurement result.

Embodiments of the present disclosure may provide a communication method performed by the AP. The communication method may include: determining a trigger frame, where the trigger frame includes a type identifier, and the type identifier is set for the trigger frame used to trigger feeding back a measurement result of a sensing measurement instance corresponding to at least one sensing measurement setup; and sending the trigger frame.

Embodiments of the present disclosure may provide a communication method performed by the AP. The communication method may include: determining a trigger frame, where the trigger frame is used to trigger feeding back a measurement result of a sensing measurement instance corresponding to at least one sensing measurement setup identifier, and the trigger frame includes: a start value of the at least one sensing measurement setup identifier and an end value of the at least one sensing measurement setup identifier; and sending the trigger frame.

Embodiments of the present disclosure may provide a communication method performed by the AP. The communication method may include: determining a trigger frame, where the trigger frame is used to trigger feeding back a measurement result of a sensing measurement instance corresponding to at least one sensing measurement setup identifier, and the trigger frame includes: a start value of the at least one sensing measurement setup identifier and a number of the at least one sensing measurement setup identifier; and sending the trigger frame.

Embodiments of the present disclosure may provide a communication method performed by the AP. The communication method may include: determining a trigger frame, where the trigger frame is used to trigger feeding back a measurement result of at least one sensing measurement instance identifier corresponding to each of at least one sensing measurement setup, and the trigger frame includes: a starting value of the at least one sensing measurement instance identifier and an end value of the at least one sensing measurement instance identifier; and sending the trigger frame.

Embodiments of the present disclosure may provide a communication method performed by the AP. The communication method may include: determining a trigger frame, where the trigger frame is used to trigger feeding back a measurement result of at least one sensing measurement instance identifier corresponding to each of at least one sensing measurement setup, and the trigger frame includes: a starting value of the at least one sensing measurement instance identifier and a number of the at least one sensing measurement instance identifier; and sending the trigger frame.

Embodiments of the present disclosure may provide a communication method performed by the AP. The communication method may include: determining a trigger frame, where the trigger frame is used to trigger feeding back a measurement result of at least one sensing measurement instance identifier corresponding to each of at least one sensing measurement setup identifier, and the trigger frame includes: a start value of the at least one sensing measurement setup identifier, an end value of the at least one sensing measurement setup identifier, and a start value and an end value of the at least one sensing measurement instance identifier corresponding to each of the at least one sensing measurement setup identifier; and sending the trigger frame.

Embodiments of the present disclosure may provide a communication method performed by the AP. The communication method may include: determining a trigger frame, where the trigger frame is used to trigger feeding back a measurement result of at least one sensing measurement instance identifier corresponding to each of at least one sensing measurement setup identifier, and the trigger frame includes: a start value of the at least one sensing measurement setup identifier, an end value of the at least one sensing measurement setup identifier, and a starting value of the at least one sensing measurement instance identifier and a number of the at least one sensing measurement instance identifier corresponding to each of the at least one sensing measurement setup identifier; and sending the trigger frame.

Embodiments of the present disclosure may provide a communication method performed by the AP. The communication method may include: determining a trigger frame, where the trigger frame is used to trigger feeding back a measurement result of at least one sensing measurement instance identifier corresponding to each of at least one sensing measurement setup identifier, and the trigger frame includes: a start value of the at least one sensing measurement setup identifier, a number of the at least one sensing measurement setup identifier, and a start value and an end value of the at least one sensing measurement instance identifier corresponding to each of the at least one sensing measurement setup identifier; and sending the trigger frame.

Embodiments of the present disclosure may provide a communication method performed by the AP. The communication method may include: determining a trigger frame, where the trigger frame is used to trigger feeding back a measurement result of at least one sensing measurement instance identifier corresponding to each of at least one sensing measurement setup identifier, and the trigger frame includes: a start value of the at least one sensing measurement setup identifier, a number of the at least one sensing measurement setup identifier, and a start value of the at least one sensing measurement instance identifier and a number of the at least one sensing measurement instance identifier corresponding to each of the at least one sensing measurement setup identifier; and sending the trigger frame.

In addition, the above-mentioned embodiments may be combined with the communication method of FIG. 2. For example, blocks 310 and 320 of FIG. 3 may be performed after block 220 of FIG. 2. For conciseness, repeated descriptions are omitted here.

FIG. 4 is a flowchart of a communication method according to another embodiment. The communication method as shown in FIG. 4 is performed by a responder (e.g., STA).

As shown in FIG. 4, in block 410, a NDPA frame is received, where the NDPA frame carries a sensing measurement setup identifier; in block 420, a NDP frame is received; in block 430, a sensing measurement corresponding to the sensing measurement setup identifier is performed according to the NDPA frame and the NDP frame; in block 440, a trigger frame is received, where the trigger frame includes first information, and the first information indicates feeding back a measurement result of a sensing measurement instance corresponding to at least one sensing measurement setup; in block 450, the measurement result is sent according to the trigger frame.

According to an embodiment of the present disclosure, the first information includes: at least one sensing measurement setup identifier respectively corresponding to the at least one sensing measurement setup.

According to an embodiment of the present disclosure, the at least one sensing measurement setup identifier includes: a start value of the at least one sensing measurement setup identifier and an end value of the at least one sensing measurement setup identifier.

According to an embodiment of the present disclosure, the at least one sensing measurement setup identifier includes: a start value of the at least one sensing measurement setup identifier and a number of the at least one sensing measurement setup identifier.

According to an embodiment of the present disclosure, the first information further includes: at least one sensing measurement instance identifier corresponding to each of the at least one sensing measurement setup identifier.

According to an embodiment of the present disclosure, the at least one sensing measurement instance identifier includes: a start value of the at least one sensing measurement instance identifier and an end value of the at least one sensing measurement instance identifier.

According to an embodiment of the present disclosure, the at least one sensing measurement instance identifier includes: a start value of the at least one sensing measurement instance identifier and a number of the at least one sensing measurement instance identifier.

According to an embodiment of the present disclosure, the trigger frame further includes: a type identifier for indicating that the trigger frame is a frame instructing to feed back the measurement result.

According to an embodiment of the present disclosure, the first information is included in a common information field of the trigger frame.

According to an embodiment of the present disclosure, the common information field further includes: a bandwidth for feeding back the measurement result.

According to an embodiment of the present disclosure, in block 450, the measurement result is sent with the bandwidth.

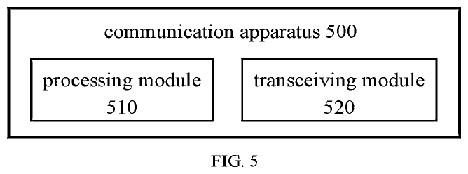

FIG. 5 is a block diagram illustrating a communication apparatus according to an embodiment. The communication apparatus 500 of FIG. 5 may include a processing module 510 and a transceiving module 520. In an embodiment of the present disclosure, the communication apparatus 500 shown in FIG. 5 may be applied to an initiator (AP). In another embodiment of the present disclosure, the communication apparatus 500 shown in FIG. 5 may be applied to a responder (STA).

In the case where the communication apparatus 500 shown in FIG. 5 is applied to the initiator (AP), the transceiver module 520 is configured to: send a NDPA frame, where the NDPA frame carries a sensing measurement setup identifier; send a NDP frame; and send a trigger frame, where the trigger frame includes first information, and the first information indicates feeding back a measurement result of a sensing measurement instance corresponding to at least one sensing measurement setup. The processing module 510 is configured to: control the overall operation of the communication apparatus 500, for example, determine information of the NDPA frame, NDP frame, and/or the trigger frame, and control the transceiving module 520 to send individual frames. That is, the communication apparatus 500 shown in FIG. 5 may perform the communication method described with reference to FIGS. 2 and 3, and the embodiments described with reference to Tables 1 to 4 and other modified embodiments may be applied thereto. In order to avoid redundancy, repeated descriptions are omitted here.

In the case where the communication apparatus 500 shown in FIG. 5 is applied to the responder (STA), the transceiving module 520 is configured to: receive a NDPA frame, where the NDPA frame carries a sensing measurement setup identifier, receive a NDP frame, receive a trigger frame, where the trigger frame includes first information, and the first information indicates feeding back a measurement result of a sensing measurement instance corresponding to at least one sensing measurement setup, and send the measurement result according to the trigger frame; and the processing module 510 is configured to: perform sensing measurement corresponding to the sensing measurement setup identifier according to the NDPA frame and the NDP frame. That is, the communication apparatus 500 shown in FIG. 5 may perform the communication method described with reference to FIG. 4, and the embodiments described with reference to Tables 1 to 4 and other modified embodiments may be applied thereto. In order to avoid redundancy, repeated descriptions are omitted here.

It will be understood that the communication apparatus 500 shown in FIG. 5 is only an example, and the embodiments of the present disclosure are not limited thereto. For example, the communication apparatus 500 may include other modules, such as a memory module and the like. Furthermore, individual modules in communication apparatus 500 may be combined into a complex module, or may be split into individual modules.

The communication method and communication apparatus according to the embodiments of the present disclosure improve the format of the trigger frame, so that the responder can transmit at least one measurement result according to the trigger frame.

Based on the same principle as the methods provided by the embodiments of the present disclosure, embodiments of the present disclosure further provide an electronic device. The electronic device includes a processor and a memory. The memory stores machine-readable instructions (also referred to as “computer programs”). The processor is configured to execute the machine-readable instructions to implement the methods described with reference to FIGS. 2 to 4.

Embodiments of the present disclosure further provide a computer-readable storage medium having stored therein a computer program that, when executed by a processor, causes the method described with reference to FIGS. 2 to 4 to be implemented.

In the embodiments, the processor may be used to implement or execute various explanatory logical blocks, modules and circuits described in the present disclosure, and may be a central processing unit (CPU), a general-purpose processor, a digital signal processor (DSP), an application specific integrated circuit (ASIC), a field programmable gate array (FPGA) or other programmable logic devices, transistor logic devices, hardware components or any combination thereof. The processor may also be a combination that implements computing functions, such as a combination of one or more microprocessors, and a combination of a DSP and a microprocessor.

In the embodiments, the memory may be, for example, a read-only memory (ROM), a random access memory (RAM), an electrically erasable programmable read-only memory (EEPROM), a compact disc read-only memory (CD-ROM) or other optical disc storage (including compressed optical discs, laser discs, optical discs, digital versatile discs, Blu-ray discs, etc.), magnetic disk storage media or other magnetic storage devices, or any other medium that can be used to carry or store program codes in the form of instructions or data structures that can be accessed by a computer, but is not limited thereto.

It should be understood that although various steps in the flowchart of the accompanying drawings are shown in sequence as indicated by arrows, these steps are not necessarily performed in the order indicated by arrows. Unless explicitly stated in this disclosure, the execution of these steps is not strictly limited in order, and they can be executed in other orders. In addition, at least some of the steps in the flow chart of the accompanying drawings may include multiple sub-steps or multiple stages. These sub-steps or stages may be executed at the same time, or may be executed at different times. Further, it does not necessarily need to perform the steps sequentially, they may be performed in turn or alternately with other steps or sub-steps of other steps or at least part of the stages.

While the present disclosure has been shown and described with reference to the embodiments, those skilled in the art will understand that various changes may be made in form and detail without departing from the scope of the present disclosure. Therefore, the scope of the present disclosure should not be limited to the embodiments, but should be defined by the appended claims and their equivalents.

1. A communication method, performed by an access point (AP), the communication method comprising:
sending a null data packet announcement (NDPA) frame, wherein the NDPA frame carries a sensing measurement setup identifier;
sending a null data packet (NDP) frame; and
sending a trigger frame, wherein the trigger frame comprises first information, and wherein the first information indicates feeding back a measurement result of a sensing measurement instance corresponding to at least one sensing measurement setup.

2. The communication method according to claim 1, wherein the first information comprises: at least one sensing measurement setup identifier respectively corresponding to the at least one sensing measurement setup.

3. The communication method according to claim 2, wherein the at least one sensing measurement setup identifier comprises: a start value of the at least one sensing measurement setup identifier and an end value of the at least one sensing measurement setup identifier, or
wherein the at least one sensing measurement setup identifier comprises: a start value of the at least one sensing measurement setup identifier and a number of the at least one sensing measurement setup identifier.

4. The communication method according to claim 2, wherein the first information further comprises: at least one sensing measurement instance identifier corresponding to each of the at least one sensing measurement setup identifier.

5. The communication method according to claim 4, wherein the at least one sensing measurement instance identifier comprises: a start value of the at least one sensing measurement instance identifier and an end value of the at least one sensing measurement instance identifier, or
wherein the at least one sensing measurement instance identifier comprises: a start value of the at least one sensing measurement instance identifier and a number of the at least one sensing measurement instance identifier.

6. The communication method according to claim 1, wherein the first information is comprised in a common information field of the trigger frame.

7. The communication method according to claim 6, wherein the common information field further comprises: a bandwidth for feeding back the measurement result.

8. The communication method according to claim 1, wherein the trigger frame further comprises: a type identifier for indicating that the trigger frame is a frame instructing to feed back the measurement result.

9. A communication method, performed by a station (STA), the communication method comprising:
receiving a null data packet announcement (NDPA) frame, wherein the NDPA frame carries a sensing measurement setup identifier;
receiving a null data packet (NDP) frame;
performing a sensing measurement corresponding to the sensing measurement setup identifier according to the NDPA frame and the NDP frame;
receiving a trigger frame, wherein the trigger frame comprises first information, and wherein the first information indicates feeding back a measurement result of a sensing measurement instance corresponding to at least one sensing measurement setup;
sending the measurement result according to the trigger frame.

10. The communication method according to claim 9, wherein the first information comprises: at least one sensing measurement setup identifier respectively corresponding to the at least one sensing measurement setup.

11. The communication method according to claim 10, wherein the at least one sensing measurement setup identifier comprises: a start value of the at least one sensing measurement setup identifier and an end value of the at least one sensing measurement setup identifier, or
wherein the at least one sensing measurement setup identifier comprises: a start value of the at least one sensing measurement setup identifier and a number of sensing measurement the at least one setup identifier.

12. The communication method according to claim 10, wherein the first information further comprises: at least one sensing measurement instance identifier corresponding to each of the at least one sensing measurement setup identifier.

13. The communication method according to claim 12, wherein the at least one sensing measurement instance identifier comprises: a start value of the at least one sensing measurement instance identifier and an end value of the at least one sensing measurement instance identifier, or
wherein the at least one sensing measurement instance identifier comprises: a start value of the at least one sensing measurement instance identifier and a number of the at least one sensing measurement instance identifier.

14. The communication method according to claim 9, wherein the first information is comprised in a common information field of the trigger frame.

15. The communication method according to claim 14, wherein the common information field further comprises: a bandwidth for feeding back the measurement result,
wherein sending the measurement result according to the trigger frame comprises: sending the measurement result with the bandwidth.

16. The communication method according to claim 9, wherein the trigger frame further comprises: a type identifier for indicating that the trigger frame is a frame instructing to feed back the measurement result.

17-18. (canceled)

19. An access point, comprising:
a memory, a processor, and a computer program stored in the memory and executable by the processor, wherein the processor is configured to
send a null data packet announcement (NDPA) frame, wherein the NDPA frame carries a sensing measurement setup identifier,
send a null data packet (NDP) frame, and
send a trigger frame, wherein the trigger frame comprises first information, and wherein the first information indicates feeding back a measurement result of a sensing measurement instance corresponding to at least one sensing measurement setup.

20. A non-transitory computer-readable storage medium having stored therein a computer program that, when executed by a processor, causes the processor to perform the method according to claim 1.

21. A station, comprising:
a memory, a processor, and a computer program stored in the memory and executable by the processor, wherein the processor is configured to perform the method according to claim 9.

22. A non-transitory computer-readable storage medium having stored therein a computer program that, when executed by a processor, causes the processor to perform the method according to claim 9.
